(19) United States
(12) Patent Application Publication
(10) Pub. No.: US 2006/0082882 A1
(43) Pub. Date: Apr. 20, 2006

(54) Achromatic imaging lens with extended depth of focus

(76) Inventors: Michael Renxun Wang, Pinecrest, FL (US); Jianwen Yang, Miami, FL (US)

Correspondence Address: MICHAEL J. BUCHENHORNER, ESQ;HOLLAND & KNIGHT, 701 BRICKELL AVENUE, MIAMI, FL, 33131, US

(21) Appl. No.: 10/965,519

(22) Filed: Oct. 14, 2004

(51) Int. Cl. G02B 26/08; G02B 5/18; G02B 27/42; G02B 3/00; G02B 7/00; G02B 9/00; G02B 11/00; G02B 13/00; G02B 15/00; G02B 17/00; G02B 25/00

(52) U.S. Cl. 359/558; 359/642

(57) ABSTRACT

A lens includes a diffractive surface having an etched structure and a refractive surface having a curved structure. The lens reduces chromatic aberration of incident light and extends depth of focus. In one alternative, the etched structure is a calculated phase pattern or a pattern that is embossed or diamond tuned. In another alternative, the curved structure is convex shaped or concave shaped. In yet another alternative, the lens is an imaging lens wherein high lateral resolution of incident light is preserved.

### STATEMENT REGARDING FEDERALLY SPONSORED-RESEARCH OR DEVELOPMENT

This invention was made with U.S. Government support under contract DMI-0319169 awarded by the National Science Foundation. The Government has certain rights in the invention.

### CROSS-REFERENCE TO RELATED APPLICATIONS

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of optics and more particularly relates to the field of optical imaging lenses.

### BACKGROUND OF THE INVENTION

Optical systems that simultaneously exhibit long focal depth and high lateral resolution find considerable applications in many different fields, e.g., microscopy, optical alignment, imaging, and optical interconnection. However, according to scaling and paraxial approximations, conventional optical lenses obey the following well-known relationships:
ΔX=k₁λ/NA, ΔZ=k₂λ/NA², (1)
where ΔX is the minimum resolvable feature size in the transverse dimension, ΔZ is the depth of focus, λ is the light wavelength, NA represents the system numerical aperture, and k₁ and k₂ are constants that depend on the criteria adopted, respectively.

According to Eq. (1), increasing the focal depth ΔZ simultaneously enlarges the transverse minimum resolvable feature size ΔX (decreasing transverse resolution), a well-known tradeoff in the photographic and imaging community. As a result, large depth of focus requires small numerical apertures, whereas high resolution demands large apertures. Thus, conventional optical elements cannot produce a beam with long focal depth and high lateral (or transverse) resolution concurrently. They can only achieve increased depth of focus through aperture reduction (decreasing NA), which correspondently reduces the amount of light capturing and transversal resolution the system can attain.

Over the years many different techniques that extend the depth of focus while preserving high lateral resolution have been proposed. For example, the uses of axicons have been widely researched. These conical elements have been shown to achieve both long depth of focus and high lateral resolution simultaneously. However, axicons are difficult to fabricate and concentrate only a small fraction of energy into the focused beam, resulting in low light efficiency. Optical apodizers, an element containing multiple transmitting rings with ±π phase variations, have also been widely investigated. Yet these elements suffer from a decrease of optical power at the image plane, and from a decrease of transversal resolution that is due to obstructed aperture.

Other approaches consist of computer-generated holograms (holographic optical elements) and diffractive optical elements (DOE) that make use of pseudo non-diffracting beams or related techniques. Pseudo-non-diffracting beams (PNDB) are characterized by a nearly constant axial intensity distribution over a finite axial region and by a beamlike shape in the transverse dimension. For monochromatic illumination, these techniques exhibit high efficiency and good uniformity along the optical axis. However, because of the high wavelength sensitivity of DOEs, for broadband illumination these elements suffer from unacceptably high chromatic aberration.

Wave-front coding digital restoration techniques have also been applied with ample success to resolve the focal depth/resolution imaging problem, but these approaches require additional signal and image processing, which require a large computing effort.

Therefore, there is a need to overcome problems with the prior art as discussed above, and more particularly a need for an imaging lens that reduces achromatic aberration and increases depth of focus, while preserving high lateral resolution.

### SUMMARY OF THE INVENTION

Briefly, according to an embodiment of the invention, a lens includes a diffractive surface having an etched structure and a refractive surface having a curved structure. The lens reduces chromatic aberration of incident light and extends depth of focus. In one embodiment of the present invention, the etched structure is a calculated phase pattern or a pattern that is embossed or diamond tuned. In another embodiment, the curved structure is convex shaped or concave shaped. In yet another embodiment, the lens is an imaging lens wherein high lateral resolution of incident light is preserved.

In another embodiment of the invention, a lens includes a diffractive surface having an etched structure and a refractive element having varying densities. Chromatic aberration of incident light is reduced and depth of focus is extended. In another embodiment, the etched structure is a calculated phase pattern or a pattern that is embossed or diamond tuned. In yet another embodiment, the refractive element is a graded index lens. In yet another embodiment, the lens is an imaging lens wherein high lateral resolution of incident light is preserved.

In another embodiment of the invention, a lens assembly includes a diffractive lens having an etched structure and a refractive lens having a curved structure, the refractive lens being coupled to the diffractive lens. Chromatic aberration of incident light is reduced and depth of focus is extended. In yet another embodiment, the etched structure is a calculated phase pattern or a pattern that is embossed or diamond tuned. In yet another embodiment, the curved structure is convex shaped or concave shaped. In yet another embodiment, the lens is an imaging lens wherein high lateral resolution of incident light is preserved.

In another embodiment of the invention, a lens assembly includes a diffractive lens having an etched structure and a refractive lens having a curved structure, the refractive lens being coupled to the diffractive lens. Depth of focus of incident light is extended and the diffractive lens and the refractive lens satisfy the following equations:
P=Pᵣ+P_{d} and Pᵣ/Vᵣ+P_{d}/V_{d}=0,
wherein P is total lens assembly optical power, Pᵣ is optical power of the refractive lens, P_{d} is optical power of the diffractive lens, Vᵣ is an Abbe number of the refractive lens material and V_{d} is the equivalent material Abbe number of the diffractive lens.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a diagram depicting a hybrid achromatic imaging lens for extended depth of focus, in one embodiment of the present invention.

FIG. 1B is a diagram depicting a conventional refractive imaging lens.

FIG. 2 is a ray diagram depicting the rotational symmetric optical system for diffractive optical element design.

FIG. 3A is a ray diagram depicting chromatic focusing property of a conventional refractive imaging lens.

FIG. 3B is a ray diagram depicting chromatic focusing property of a diffractive imaging lens.

FIG. 3C is a table showing how to achieve different f-numbers of a hybrid lens using different combinations of f/#s of refractive and diffractive lenses.

FIG. 4A is a simulated intensity distribution graph plotted along the z-axis of a diffractive optical lens with extended depth of focus.

FIG. 4B is a phase distribution graph plotted along the radius of the diffractive optical lens with extended depth of focus.

FIG. 4C is an on-axis intensity distribution graph plotted along the z-axis for both the diffractive-refractive hybrid lens (solid curve) and a conventional refractive lens (dashed curve) of f/1.

FIG. 5 is a block diagram showing an experimental configuration for an experiment including one embodiment of the present invention.

FIG. 6 shows four image results observed at different planes from the diffractive optical lens element at (a) 24.6, (b) 25.0, (c) 25.4, and (d) 25.93 mm using the experimental configuration of FIG. 5.

FIGS. 7A-7D show intensity distribution graphs plotted along the z-axis for images of FIG. 6.

FIGS. 8A-8C show simulated intensity distribution graphs plotted along the z-axis for three arbitrary wavelengths: (A) before achromatization, (B) after achromatization, and (C) for a conventional f/1 SF11 lens.

FIG. 9 is a three-dimensional intensity distribution graph plotted along the z-axis and along the radius showing extended depth of focus behavior.

FIG. 10 is an experimentally measured intensity distribution graph plotted along the optical axis of the hybrid lens showing that the long depth of focus has been achieved.

FIG. 11 shows four image results observed at (a) 2.999, (b) 3.000 (c) 3.001, and (d) 3.002 mm from a conventional f/1 lens. The measured depth of focus is 2.6 μm.

FIG. 12 shows four image results observed at (a) 2.990, (b) 2.997, (c) 3.005, and (d) 3.01 mm from a fabricated hybrid achromatic imaging lens of FIG. 1, in one embodiment of the present invention.

FIGS. 13 are (A) a simulation plot of the transverse resolution of an SF11 f/1 lens, measured transverse resolution for (B) a conventional f/1 lens and (C) the hybrid f/1 lens.

FIG. 14 is a diffraction-limited simulation result demonstrating a comparison of resolution between extended depth of focus and conventional lenses.

FIG. 15 shows four image results at different illumination wavelengths using a conventional lens.

FIG. 16 shows four image results at different illumination wavelengths using the hybrid achromatic imaging lens of FIG. 1, in one embodiment of the present invention.

FIG. 17 shows focus-free images of a 228-line pair/mm resolution target at different distance from the lens when the hybrid f/1 imaging lens was used, in one embodiment of the present invention.

FIG. 18 shows four image results of a 228-line pair/mm target pattern using a conventional f/1 lens.

### DETAILED DESCRIPTION

The present invention discloses a design for an achromatic hybrid refractive-diffractive lens that extends the depth of focus (DOF) without sacrificing the system's transverse resolution. The extended DOF lens combines a specially designed DOE that generates a long range of pseudo-non-diffractive rays with a corresponding refractive lens to diminish chromatic aberrations in the desired spectral band. Utilizing a hybrid refractive-diffractive device configuration simultaneously preserves the favorable properties of both the diffractive element (long focal depth) and the refractive lens (low chromatic aberration, high-energy concentration).

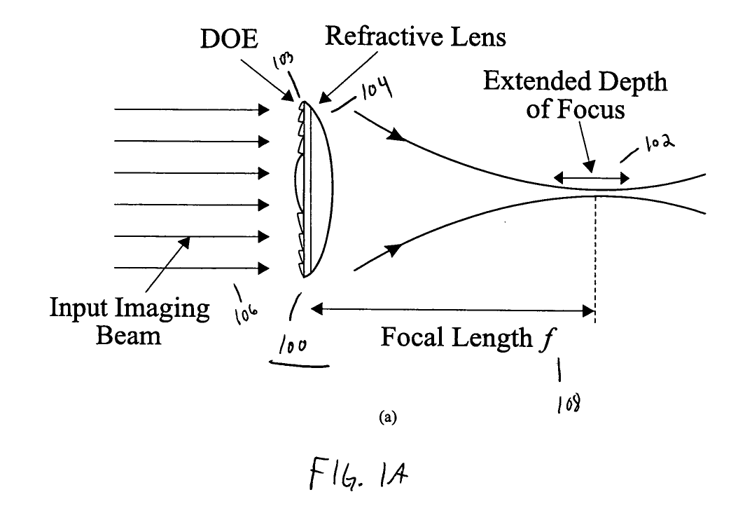

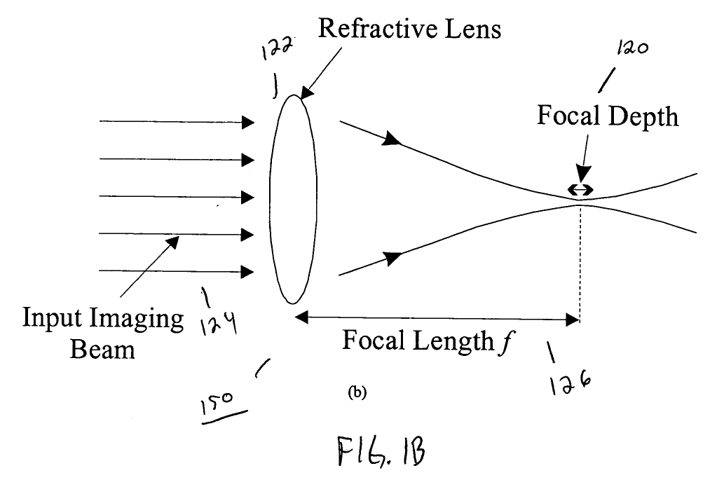

The present invention can be used with various optical wavebands for focal depth extension. The present invention operates in the entire visible waveband and extends the DOF of a lens tenfold, as shown in experimental results, without decreasing any lateral resolution. FIG. 1A shows a schematic of the hybrid lens 100 of the present invention. FIG. 1B shows a conventional lens for focusing a collimated imaging beam. With regards to FIG. 1A, the hybrid lens 100 comprises a DOE 103 coupled with a refractive lens 104. An input imaging beam 106 incident to the hybrid lens 100 results in a processed beam with extended depth of focus 102 at focal length 108.

From a geometrical optics viewpoint, the principle of extended focal depth 102 of the hybrid lens 100 may be regarded as a non-conventional lens with longitudinally stretched focus of constant intensity distribution. Such an extended DOF 102 hybrid lens 100 results in a fast f/1 lens with chromatic aberration correction in the visible spectral band. The fabricated hybrid lens 100 demonstrates significant DOF improvement while retaining high transversal resolution displayed by conventional f/1 lenses. Such a lens has considerable applications in imaging systems and optical microscopy to minimize focus adjustment in high-resolution settings.

FIG. 1A shows a hybrid lens 100 including a diffractive lens 103 coupled to a refractive lens 104. In an embodiment of the present invention, the combination of the diffractive lens 103 and the refractive lens 104 allows for the depth of focus of incident light to be extended and the diffractive lens and the refractive lens satisfy the following equations:
P=Pᵣ+P_{d} and Pᵣ/Vᵣ+P_{d}/V_{d}=0,
wherein P is total lens assembly optical power, Pᵣ is optical power of the refractive lens, P_{d} is optical power of the diffractive lens, Vᵣ is an Abbe number of the refractive lens material and V_{d} is the equivalent material Abbe number of the diffractive lens.

In another embodiment of the present invention, the hybrid lens 100 is not comprised of two lens coupled together (including a diffractive lens 103 coupled to a refractive lens 104) but rather one lens that has been formed from a single optical element. In this embodiment, the hybrid lens comprises a diffractive surface having an etched structure and a refractive surface having a curved structure, wherein chromatic aberration of incident light is reduced and depth of focus is extended. The etched surface structure is a calculated phase pattern that is etched, embossed, or diamond tuned. The manner in which the etched structure can be manufactured is discussed in greater detail below. Moreover, the curved structure, can be concave shaped or convex shaped. In another embodiment, the hybrid lens is an imaging lens. In yet another embodiment, the high lateral resolution of incident light is preserved.

As explained above, the hybrid lens 100 includes a diffractive lens 103 coupled to a refractive lens 104. In another embodiment of the present invention, the refractive lens 104 comprises a refractive element having varying densities such as a graded index lens, also known as a gradient index lens or a variable index lens.

With regards to FIG. 1B, the refractive lens 150 processes an input imaging beam 124 incident to the lens 150 and results in a processed beam with conventional depth of focus 120 at focal length 126. Note that the depth of focus 120 is smaller than the extended depth of focus 102 at focal length 108 of FIG. 1A.

As described above, the present invention provides extended depth of focus. The manner in which the present invention provides extended depth of focus is described in greater detail below. A diffractive optical element is a wavefront processor capable of transforming light into many complex patterns otherwise difficult to attain using conventional optics. DOEs offer several advantages over conventional optical elements such as being thin, lightweight, and inexpensive (especially when mass-produced). Advances in design, fabrication, and analysis of DOEs have made them a viable alternative to refractive elements in many optical systems.

There are two major approaches for the design and simulation of long focal depth DOEs. One method utilizes the geometric law of energy conservation for evaluating the desired phase transmittance with simple analytical solutions. This technique produces low accuracy results with minimal computation time. The present invention employs the iterative optimization approach where an algorithm searches for an optimal phase distribution to satisfy a desired output intensity pattern. Several iterative optimization techniques such as Simulated Annealing (SA), and Radially Symmetric Iterative Discrete On-Axis Encoding (RSIDO) have been widely reported. The RSIDO algorithm in particular has been shown to generate high efficiency fast f-number diffractive lenses.

Other iterative methods such as phase retrieval (i.e., the Gerchberg-Saxton algorithm, the Yang-Gu algorithm and its modified versions) employ error-reduction methods to derive a phase distribution satisfying a desired intensity mapping. Each of these approaches has been proven successful for numerous DOE designs. The conjugate-gradient algorithm, a powerful technique for dealing with optimization problems, is a sufficient candidate for the long focal depth DOE design.

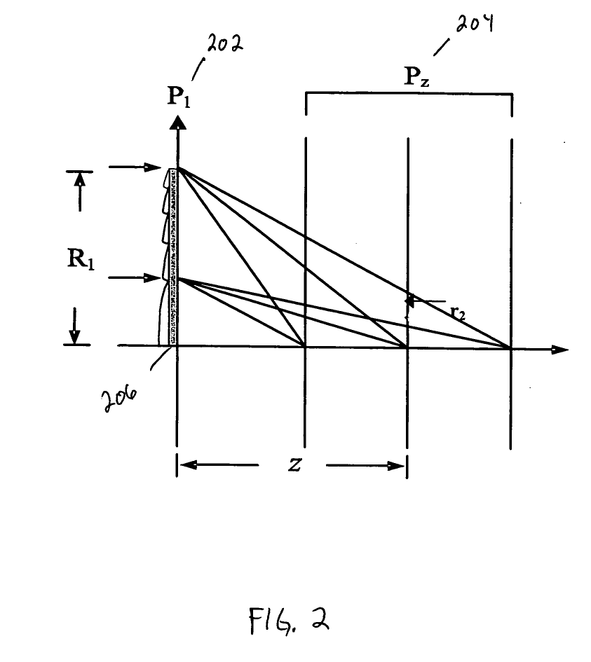

FIG. 2 shows a schematic of a rotationally symmetric optical system for extended DOF, where the DOE 206 is placed on the input plane P₁, denoted by 202, and P_{z}, denoted by 204, represents the output observation plane. Letting u₁ (r₁) and u₂ (r₂) represent the field distributions at the input (z=0) and output observation planes, respectively, the corresponding wave functions may be expressed as
u₁(r₁)=ρ₁(r₁)exp(iφ₁(r₁)) (2)
u₂(r₂,z)=ρ₂(r₂,z)exp(iφ₂(r₂,z)), (3)
where φ₁ represents the phase distribution of the DOE, φ₂ expresses the output plane phase distribution, and the input and output field amplitudes are given by ρ₁, and ρ₂, respectively. In addition, r₁ and r₂ denote the input and output radial coordinates, respectively.

In accordance with the Huygens-Fresnel principle, the output wave function, u₂(r₂,z) can also be represented in terms of input wave function with the following superposition integral

$${u}_{2} ( {r}_{2 ,} z ) = {\int }^{{r}_{1 max}} G ( {r}_{2} , {r}_{1} , z ) {u}_{1} ( {r}_{1} ) ⅆ {r}_{1} . \qquad ( 4 )$$

where the transform kernel, G(r₂, r₁, z) is expressed as

$$G ( {r}_{2} , {r}_{1} , z ) = \frac{2 π \cdot {r}_{1}}{j λ z} exp ( j {kr}_{01} ) . \qquad ( 5 )$$

Moreover, r₀₁ represents the polar distance between the aperture and observation planes
r₀₁=[z²+r₁²+r₂²−2r₁r₂ cos(θ₁−θ₂)]^{1/2}. (6)
Here θ₁, and θ₂ correspond to the angles subtended by the aperture and observation planes, respectively. Considering a rotationally symmetric optical system and a binomial expansion of the square root, the distance r₀₁ can be accurately approximated as

$${r}_{01} ≅ z [ 1 + \frac{1}{2} \frac{{r}_{1}^{2}}{{z}^{2}} - \frac{1}{8} \frac{{r}_{1}^{4}}{{z}^{4}} + \frac{3}{48} \frac{{r}_{1}^{8}}{{z}^{8}} ] , \qquad ( 7 )$$

where a third order approximation has been used to account for high power fast f-number lenses not in the Fresnel domain. We note that since we are mostly concerned with generating a constant axial intensity at the output plane and assuming the beamlike profile of PNDB's can be obtained automatically, the radial coordinate in the output plane has been simplified by setting r₂ to zero. Substituting Eq. (7) into Eq. (5) derives the transform kernel, G. The composite diffraction pattern can then be constructed according to Eq. (4).

Further simplification of the transform kernel is possible if the observation plane lies in the Fresnel domain. Within this region, the first two terms of Eq. (7) adequately approximate the binomial expansion. This condition is met if the higher-order terms of the expansion do not appreciably change the overall value of the superposition integral (Eq. (4)). In the Fresnel domain, the transform kernel can be reduced to

$$G ( {r}_{2} , {r}_{1} , z ) = \frac{2 π exp ( ⅈ 2 π z / λ )}{\sqrt{ⅈλ z}} \cdot exp \{ \frac{ⅈπ}{λ z} [ {r}_{2}^{2} + {r}_{1}^{2} ] \} \cdot {J}_{0} ( \frac{2 π {r}_{2} {r}_{1}}{λ z} ) \cdot {r}_{1} , \qquad ( 8 )$$

where J₀ denotes the zero-order Bessel function of the first kind.

Subsequently, note that in order to perform numerical simulations the continuous functions presented above have to be sampled and converted into discrete form. Thus, in discrete form, equations (2) and (4) can be expressed as

$$\begin{matrix}{u}_{1 , m} = {ρ}_{1 , m} exp ( {ⅈφ}_{1 , m} ) , m = 1 , 2 , … , M & ( 9 ) \\ {u}_{2 , l , z} = {\sum }_{m = 1}^{M} {G}_{l , m , z} {u}_{1 , m} , l = 1 , 2 , … , L , & ( 10 )\end{matrix}$$

with M and L representing the number of sampling points along the input and output observation planes, respectively. Hence, the goal for designing the DOE with extended DOF is to determine the phase distribution, φ₁, which can transform an input amplitude pattern (u_{1,m}) into the desired field distribution (u_{2,l,z}) with constant value (ρ₂₀) along the optical axis in a preset range. Assuming the total number of observation planes N_{z} are along the z axis, the estimated difference between the desired and the actual field distribution is

$$E = {\sum }_{q = 1}^{{N}_{z}} W ( q ) \{ {\sum }_{l = 1}^{L} {[ {ρ}_{20} ( l ) - \vert {\sum }_{m = 1}^{M} {G}_{1 , l , m , z} {ρ}_{1 , m} exp ( {ⅈφ}_{1 , m} ) \vert ]}^{2} \} , \qquad ( 11 )$$

where a weighting factor W(q) satisfying the normalizing condition

$${\sum }_{q = 1}^{{N}_{z}} W ( q ) = 1$$

has been introduced. As a result, the DOE design algorithm entails finding the optimal phase φ₁ to minimize the error function, E, as calculated by Eq. (11).

Employing the conjugate-gradient method, the phase distribution φ₁ is obtained with the following iteration algorithm
φ₁^{(k+1)}=φ₁^{(k)}+τ^{(k)}d^{(k)}, k=0,1,2,3, . . . , (12)

where φ₁^{(k)}, τ^{(k)}, and d^{(k)} denote the phase, step size, and search direction in the kₜₕ iteration, respectively. The conjugate-gradient algorithm is an iterative technique that requires an initial input for the unknown variable, φ₁, and updates the variable at the kₜₕ iteration according to Eq. (12). The geometric law of energy conservation is used to set the desired amplitude ρ₂₀, and although a random initial phase φ₁⁽⁰⁾ can be used to start the iteration process, a logarithmic phase function is used:
φ₁=−½a1n(d₁+ar²)+const., (13)
where
a=(d₂−d₁)/R²,

and d₁, d₂, represents the interval of constant axial intensity, and R represents the clear DOE aperture. The logarithmic phase function derived from the geometrical law of energy conservation is also known to generate a uniform intensity distribution along the optical axis, thus allowing the algorithm to yield a more accurate solution with faster convergence. The numerical iteration process terminates when either the error E reaches a small pre-designated value or the number of iterations exceeds a given cycle. Once the optimal phase distribution for long DOF is obtained using the conjugate gradient algorithm, the approximate surface relief profile, t(r), of the DOE is acquired from the following phase-thickness relationship:

$$t ( r ) = \frac{λφ ( r )}{2 π ( n - 1 )} . \qquad ( 14 )$$

As described above, the present invention reduces chromatic aberration. The manner in which the present invention reduces chromatic aberration is described in greater detail below. DOEs are planar elements consisting of zones which retard the incident light wave by a modulation of refractive index or surface profile. The light emitting from different zones interferes and forms the desired wavefront. Since these phenomena are strongly dependent on the wavelength of light, DOEs are generally restricted to monochromatic applications. In order to combine the advantages of refractive (low dispersion, high-energy concentration) and diffractive optics (ability to implement optical functions that are difficult to attain using conventional optics), the present invention provides a hybrid refractive-diffractive lens. The hybrid lens maintains the long DOF presented above while significantly reducing chromatic aberrations for wide spectral band inputs.

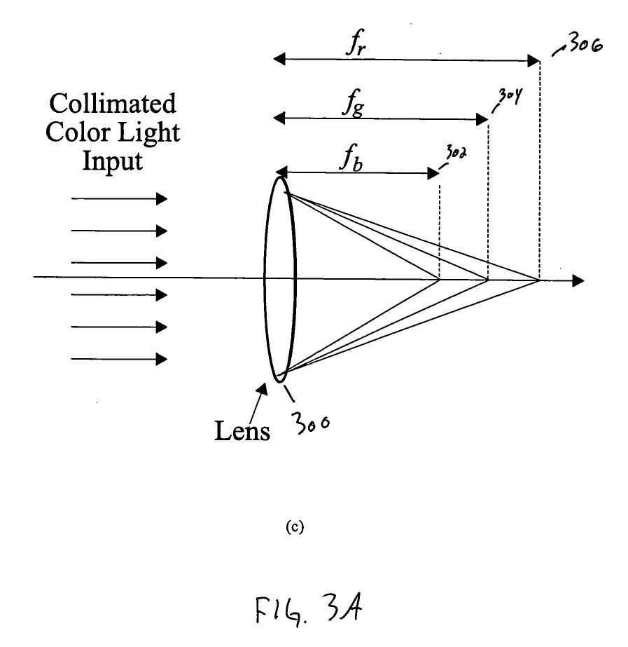

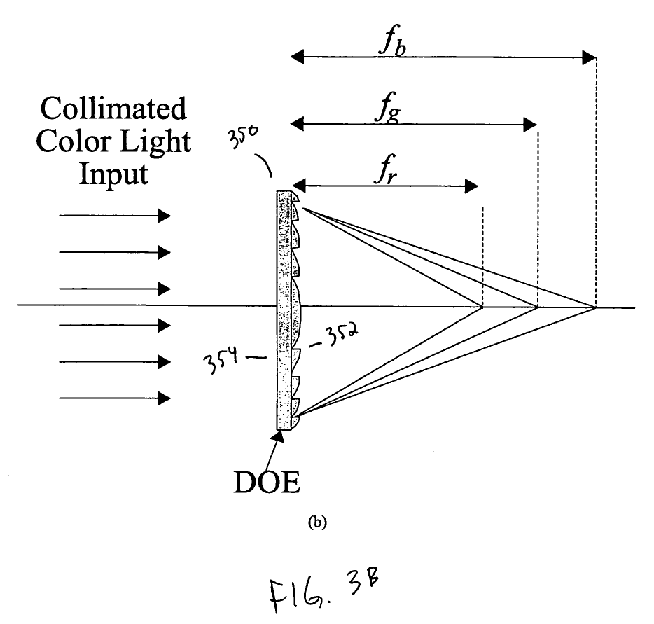

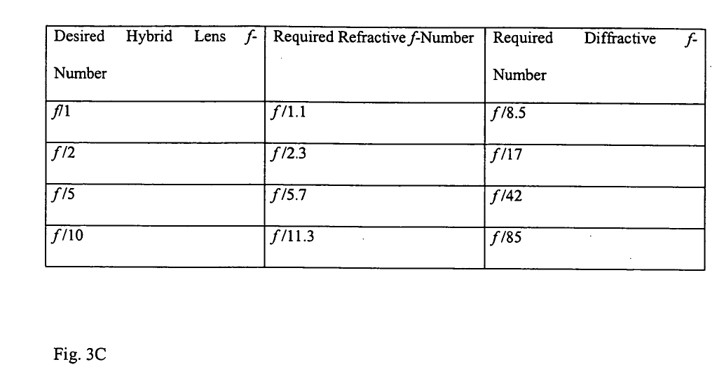

Chromatic aberration is caused by the dependence of the lens refractive index on wavelength, or dispersion. FIG. 3A shows chromatic aberration of a refractive lens while FIG. 3B shows chromatic aberration of a diffractive lens. Referring to FIG. 3A, if collimated light of broad spectral bandwidth (i.e., white light) is considered, red, green, and blue light passing through the lens 300 will focus (fᵣ, f_{g}, f_{b}, denoted by 306, 304 and 302, respectively) at different positions along the optical axis. The focal length of a conventional lens is defined as

$$\frac{1}{f ( λ )} = [ n ( λ ) - 1 ] ( \frac{1}{{R}_{1}} - \frac{1}{{R}_{2}} + \frac{t ( n ( λ ) - 1 )}{{R}_{1} {R}_{2}} ) \qquad ( 15 )$$

where t represents the lens thickness, and n characterizes the material refractive index. R₁ and R₂ are respectively the curvature radii of the two surfaces of the refractive lens. Under the hybrid configuration of the present invention, a plano-convex refractive lens is selected for easy DOE integration. Attaching the DOE to the lens' planar surface allows for simple hybrid lens construction. For a plano-convex lens the focal length is defined as

$$\frac{1}{f ( λ )} = [ n ( λ ) - 1 ] ( \frac{1}{{R}_{1}} ) \qquad ( 16 )$$

Therefore, the wavelength dependence of the material index causes the three images to be dispersed relative to each other. The property of refractive index variation with wavelength is called material dispersion, and is represented by the Abbe number, V. In the visible spectrum, the Abbe number of a refractive lens is calculated as

$${V}_{r} = \frac{{n}_{d} - 1}{{n}_{F} - {n}_{c}} , \qquad ( 17 )$$

with n_{F}, n_{d} and n_{c} corresponding to the refractive indices at the 486.1 nm, 587.6 nm, and 656.3 nm wavelengths, respectively. Note that in the visible spectrum Vᵣ is always a positive number.

Chromatic aberration has been known to be corrected through the use of achromatic doublets, where the combination of positive and negative lenses with different refractive indices, remove dispersion effects. The drawbacks to such methods are the use of two distinct optical materials and the difficult positioning and packaging necessary for the curved elements. In general, correction of chromatic aberration using two elements in contact can be satisfied under the following constraints

$$\begin{matrix}P = {P}_{1} + {P}_{2} \\ \frac{{P}_{1}}{{V}_{1}} + \frac{{P}_{2}}{{V}_{2}} = 0 ,\end{matrix} \qquad ( 18 )$$

where Pᵢ is the power (inverse focal length) of the ith lens, P is the total system power, and Vᵢ is the Abbe number of the correcting lens. Likewise, chromatic aberration can also be corrected through the use of hybrid refractive-diffractive elements. FIG. 3B shows a DOE 350 with a substrate 354. Referring to FIG. 3B, the dispersion properties of diffractive elements 352 are opposite that of refractive elements in order to diminish dispersion effects. Unlike refractive achromats, the diffractive device requires only one type of refracting material, and the curvatures are not as difficult to reproduce. The Abbe number of a diffractive element is given as

$${V}_{d} = \frac{{λ}_{d}}{{λ}_{F} - {λ}_{c}} , \qquad ( 19 )$$

where λ_{F}, λ_{d}, and λ_{c} represent wavelengths of 486.1 nm, 587.6 nm, and 656.3 nm, respectively. Thus in the visible spectrum, the Abbe number of a DOE is a (negative) constant independent of the DOE material.

When designing a hybrid lens with extended DOF only the total power (P) desired must be specified. Since the lens manufacturer provides Vᵣ, and V_{d} is constant, Eq. (18) reduces to a simple two equations-two unknowns (P₁, P₂) problem set. Solving Eq. (18), the individual powers of the refractive and diffractive lenses required to eliminate chromatic aberration can be obtained. In order to design for a hybrid lens that extends the DOF a certain distance δ_{z}, the DOE should be designed to provide a constant axial intensity along the following range:

$$\begin{matrix}\frac{1}{{P}_{near\_hyb}} = \frac{1}{P} - \frac{{δ}_{z}}{2} ; & & & \frac{1}{{P}_{far\_hyb}} = \frac{1}{P} + \frac{{δ}_{z}}{2} ,\end{matrix} \qquad ( 20 )$$

where Pₙₑₐᵣ_{_{—}}_{hyb}, and P_{far}_{_{—}}_{hyb}, correspond to the near and far field hybrid powers within the extended focal range. Inserting Eq. (20) into Eq. (18) yields the required DOE constant intensity range:

$$\begin{matrix}{P}_{d\_near} = {P}_{near\_hyb} - {P}_{r} ; & & {P}_{d\_far} = {P}_{far\_hyb} - {P}_{r} \\ {f}_{d\_near} = \frac{1}{{P}_{d\_near}} ; & & {f}_{d\_far} = \frac{1}{{P}_{d\_far}} .\end{matrix} \qquad ( 21 )$$

Here P_{d}_{_{—}}ₙₑₐᵣ, and P_{d}_{_{—}}_{far} represent the near and far field diffractive powers within the region of constant intensity. In addition, f_{d}_{_{—}}ₙₑₐᵣ, and f_{d}_{_{—}}_{far} correspond to the long DOF near and far field diffractive focal lengths, respectively. Attaching the DOE to the appropriate power refractive lens (Pᵣ) generates the desired power hybrid refractive-diffractive lens with extended focal range δ_{z} along the optical axis.

Highlighting Eq. (18), we note that since generally Vᵣ>>V_{d}, the power of the diffractive element is much lower than the refractive power. The table of FIG. 3C lists the corresponding refractive and diffractive f-numbers required to achieve certain achromatic hybrid lenses with SF11 as the refractive lens material. The table affirms that the designed DOE lies in Fresnel domain for most hybrid lens combinations. The low power diffractive lenses required for faster high-power hybrid lenses enables the design of long focal depth DOEs without having to resort to the rigorous diffraction theory. The use of scalar diffraction theory (as detailed above) leads to fast convergence times and is highly accurate in the Fresnel/Fraunhofer domain.

Furthermore, the hybrid design technique of the present invention allows excellent flexibility in refractive material selection. DOEs with long DOF can be specifically designed to combine with numerous refractive materials. Likewise, the present invention utilizes a program where the desired hybrid power, desired spectral band and the properties of the refractive material used are inputted. The program generates the required refractive power and DOE surface relief profile coordinates (via conjugate-gradient algorithm) necessary to extend the depth of focus by a factor of ten around the desired hybrid power. For example, to design a UV hybrid lens with quartz as the refractive material, a DOE can be designed based on the optical properties of quartz. Similar DOEs can be designed for visible and infrared hybrid lenses as well.

The DOE 103 of the present invention is a phase filter element. Numerous techniques such as diamond turning, photolithography, and laser writing are used for DOE fabrication. Likewise, phase filter elements can be manufactured by laser generation of gray-level masks and a technique for the fabrication of phase-only diffractive optical elements by one-step direct etching on glass mask for practical surface relief profiles. Laser-direct writing on high-energy beam sensitive (HEBS) glass produces a gray-level mask where varying laser intensity radiation upon the HEBS glass generates a corresponding gray-level transmittance pattern. Subsequently, direct etching of the gray-level mask plate by use of diluted hydrofluoric acid results in the desired DOE surface relief profile. The direct etching creates a one-step alignment-free process that can support a large number of phase levels for the fabrication of high efficiency quasi-continuous surface profile DOEs.

Etching calibration is performed to quantify the relation between etching depth and laser-written transmittance. The optimal surface profile for the extended DOF DOE derived from the conjugate-gradient algorithm is then inputted to a laser-writing machine. The fabricated DOE is then precisely aligned with the refractive lens to construct the hybrid extended DOF lens.

To illustrate the effectiveness of the hybrid extended DOF lens of the present invention, experimental data is provided below, with regards to a prototype hybrid lens with fast f-number of f/1 that works in the entire visible waveband (400 nm ˜700 nm). A plano-convex refractive lens made from SF11 glass was selected. SF11 is a flint glass with excellent chemical resistivity and adequate transmission in the visible waveband. Its refractive index is 1.7847 at the 587.6 nm design wavelength and its Abbe number Vᵣ is 25.76. The high dispersion property of SF11 is exploited in the hybrid design to complement the large dispersive nature of the diffractive element.

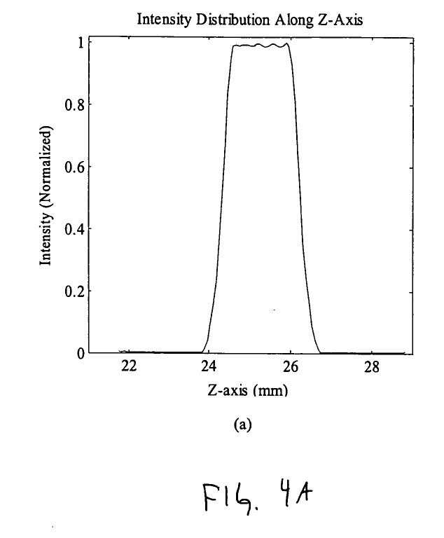

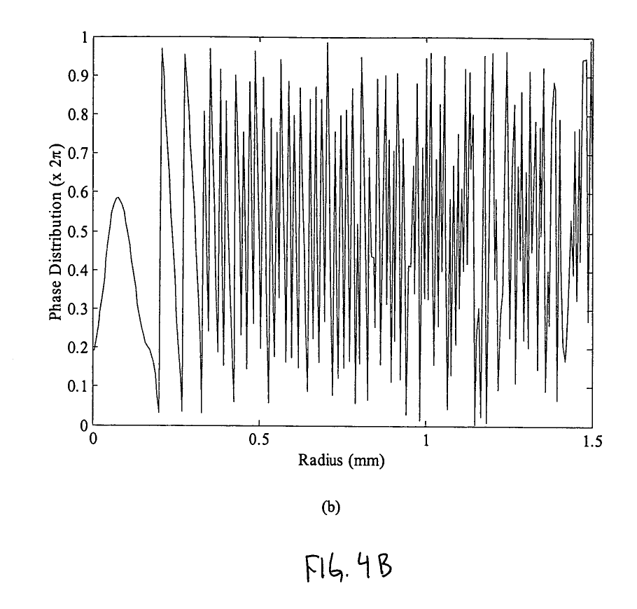

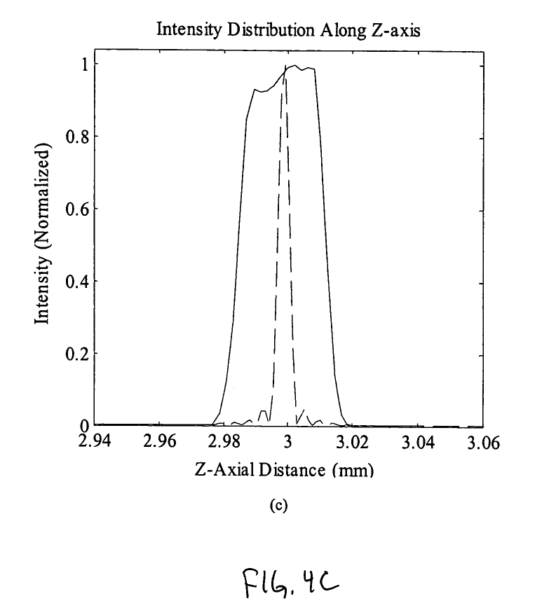

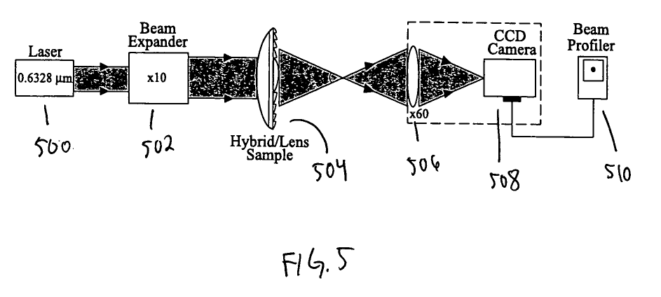

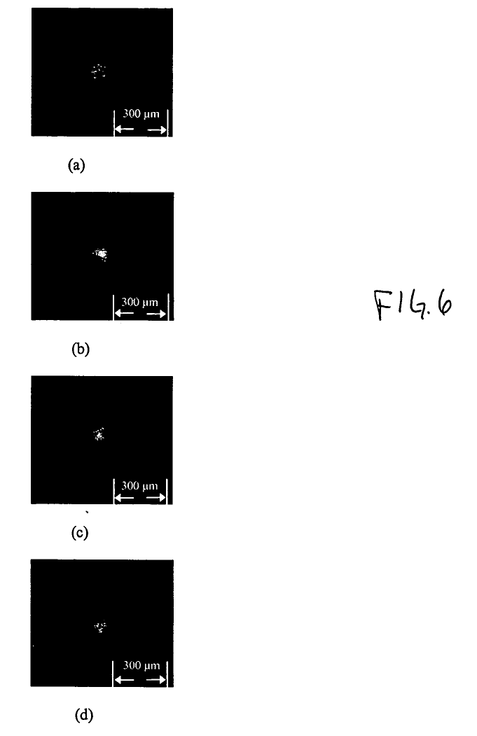

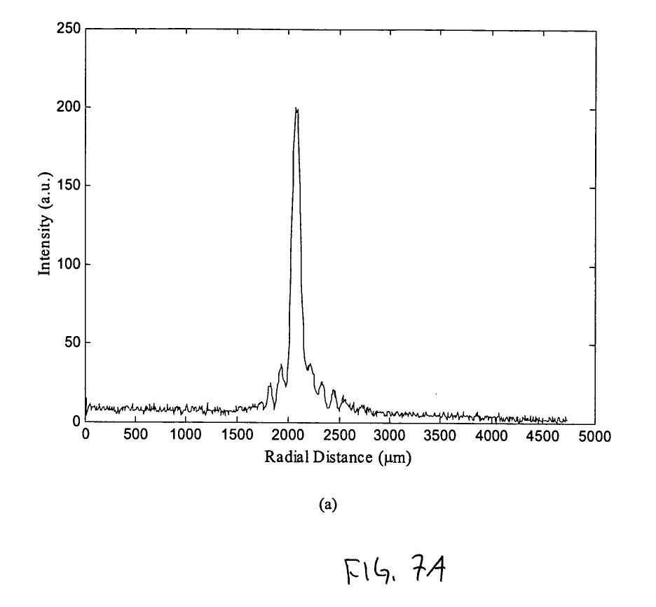

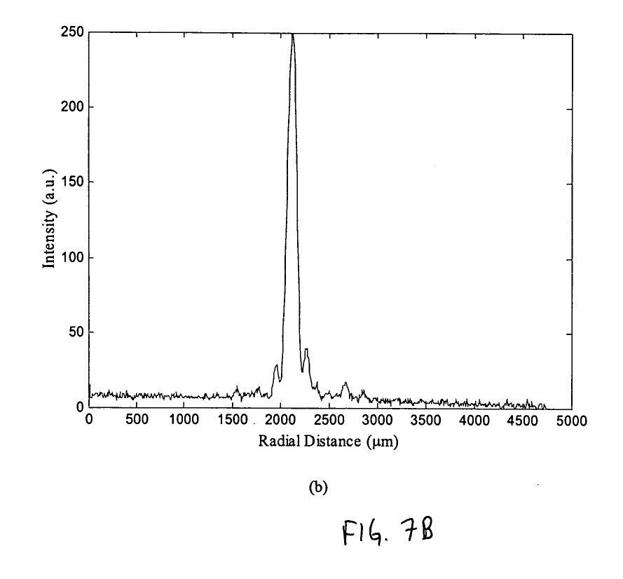

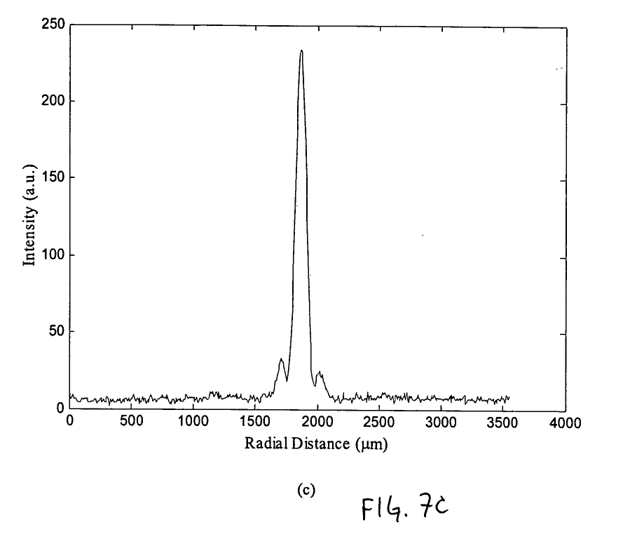

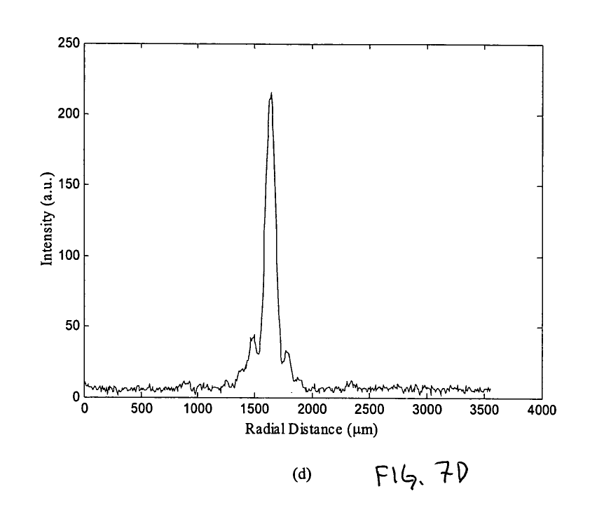

For a conventional SF11 f/1 refractive lens the DOF is approximately 2.6 μm with a diffraction-limited beam spot size of about 1 μm. The focal length of the f/1 hybrid lens was designed to be 3.0 mm. To achieve a ten times DOF improvement in this case, i.e. 26 μm depth of focus, its focal range should be from 2.987 mm to 3.013 mm. With the focal length of the hybrid system set as f_{hybrid}=3 mm, Eq. (18) is utilized to obtain the focal lengths of the diffractive and refractive lenses as f_{d}=25.4 mm, and fᵣ=3.4 mm, respectively. Employing the conjugate gradient method as discussed above, a DOE with long DOF (focal range 24.6 mm˜26.0 mm) is designed. The simulated on-axis intensity distribution of the designed long focal depth DOE is demonstrated in FIG. 4A. FIG. 4A shows a simulated on-axis intensity distribution of the designed DOE, FIG. 4B shows the corresponding simulated phase profile of the designed DOE, and FIG. 4C shows a simulation of on-axis intensity distribution of combined refractive-diffractive hybrid f/1 lens (solid), and conventional f/1 SF11 lens (dotted). When combined with the appropriate power refractive lens, the optical system should exhibit an extended focal depth around the desired system focal length, f_{hybrid}. In order to show the ten times DOF improvement the hybrid lens provides, simulated on-axis beam intensity distributions for both the hybrid f/1 lens (solid), and conventional f/1 lens (dotted), are also shown in FIG. 4C.

The simulated optimum phase function φ(r) required to produce the DOE with extended DOF is shown in FIG. 4B. This function can be converted to a surface relief profile, t(r) (via Eq. (14)), which can be utilized for the DOE fabrication. A quasi-continuous, high efficiency, diffractive lens can then be fabricated using the laser direct-write technique described above.

The point spread imaging (PSI) characteristic of the long focal depth DOE was then experimentally analyzed. FIG. 5 shows an experimental arrangement for measuring the focusing performance of long focal depth DOE and both hybrid and conventional f/1 lenses. An expanded collimated He—Ne laser beam at a 632.8 nm wavelength was used to illuminate the sample. The laser beam was emitted from a laser 500 through a beam expander 502 and into the lens 504 of the present invention. The focused spot was projected onto a charge-coupled device (CCD) image sensor 508 by a microscope objective lens (60×) 506. A 60× objective lens 506 was employed in the experimental arrangements to compensate for the limited CCD sensor resolution of 7.4 μm per pixel. The objective lens 506 and CCD device 508 were then mounted on a three-dimensional translation stage with beam profiler 510 attached to the CCD camera 508. A submicron sensitive differential micrometer, with 0.5 μm resolution, was used to sweep the objective lens 506 and CCD camera 508 across the z-axis and analyze the focusing performance of the DOE.

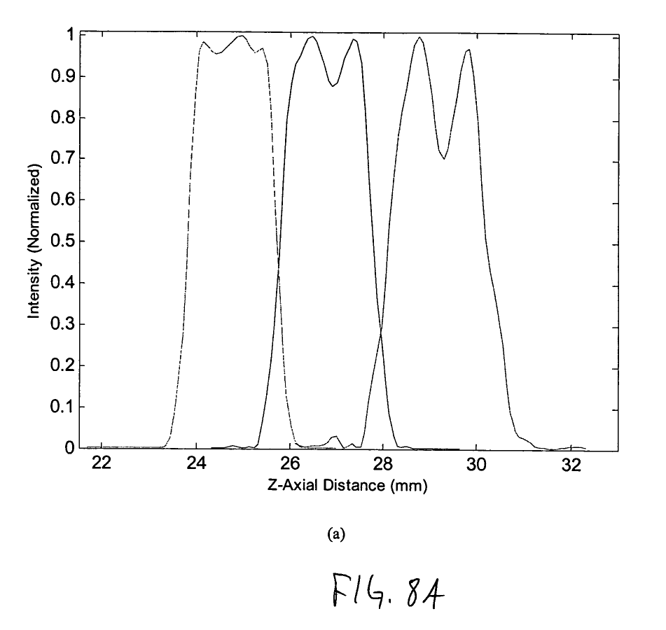

FIG. 6 shows four pictures (a, b, c and d) of the focused spot quality of the DOE. FIG. 6 shows beam spot images observed at different planes from the DOE lens at (a) 24.6 mm, (b) 25.0 mm, (c) 25.4 mm, and (d) 25.93 mm. Long depth of focus is demonstrated. FIGS. 7A, 7B, 7C and 7D show the transverse intensity distribution along the z-axis for pictures a, b, c and d of FIG. 6, respectively. FIG. 7 shows transverse intensity distribution from the fabricated DOE at 24.6 mm from the lens in FIG. 7A, at 25.0 mm from the lens in FIG. 7B, at 25.4 mm from the lens in FIG. 7CA, and at 25.93 mm from the lens in FIG. 7D. The beam remains in focus from 24.6 mm to 25.93 mm. Utilizing the diffractive depth of focus criterion of 81% peak intensity constituting the focal range, the diffractive element's extended DOF was measured to be 1.33 mm, adequately close to the designed DOE value of 1.4 mm. There is an error of 5% inherent in the wet etching process.

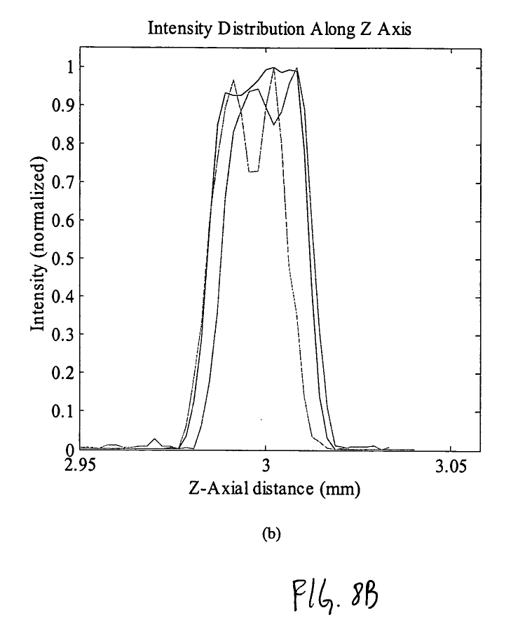

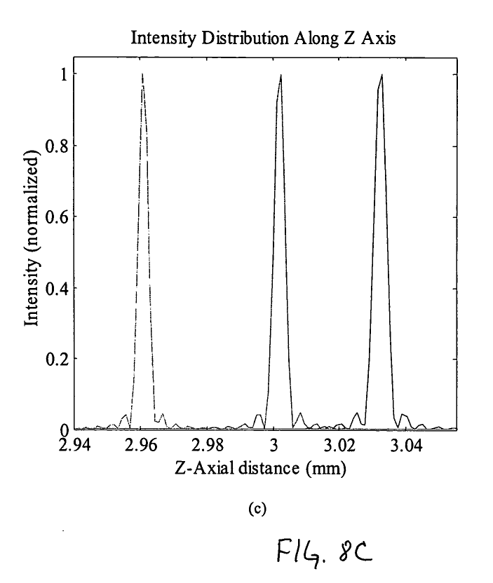

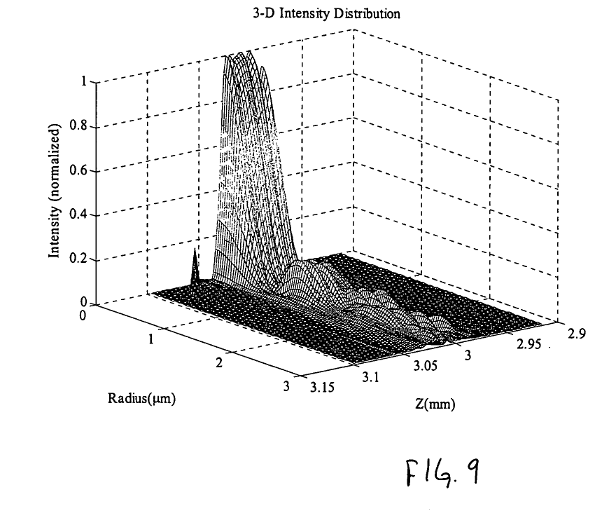

Although simulation and experimental results verify the DOE's long DOF property, the present invention will follow the design specifications only at the central wavelength ( [symbol] _{d}). As an example, a simulation of the on-axis intensity distributions behind the DOE for three arbitrary wavelengths in the visible spectrum ( [symbol] =0.47 μm, 0.53 μm, 0.62 μm) is shown in FIG. 8A. Simulated focused on-axis beam intensity distribution for the 3 arbitrary wavelengths are shown before achromatization in FIG. 8A, after achromatization in FIG. 8B, and for conventional f/1 SF11 lens in FIG. 8C. Even though the DOE extends the DOF at each wavelength there is severe chromatic aberration and reduced efficiency, as expected. The same simulation using three arbitrary wavelengths in the visible waveband was performed using the hybrid lens of the present invention. As shown in FIG. 8B, the chromatic aberration has been significantly reduced while preserving the ten times DOF improvement over a conventional f/1 lens. Likewise, the simulation was performed for a conventional f/1 lens, shown in FIG. 8C, illustrating the dispersive behavior of conventional lenses as well.

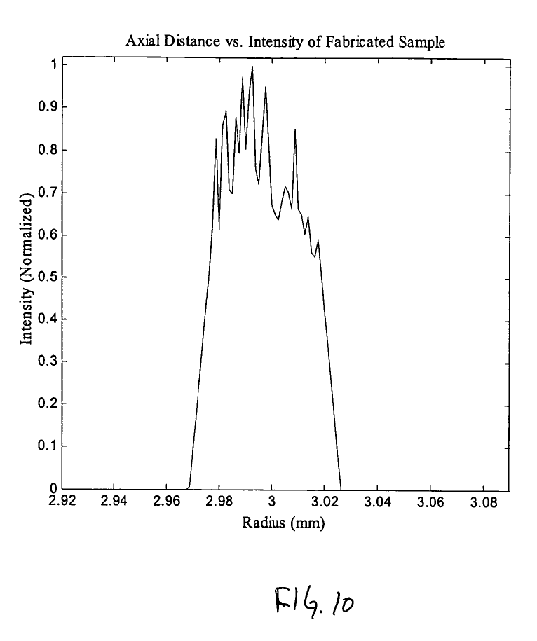

In addition to the near achromatic extended DOF properties, the f/1 hybrid lens also maintains the high transverse resolution inherent in f/1 lenses. As determined from Eq. (1) the resolution of a conventional f/1 lens is approximately 1 μm. Similarly, Eq. (1) affirms that increasing the DOF ten times (26 μm) reduces the resolving power of the system to about 4 μm. Nevertheless, simulation results reveal the hybrid lens of the present invention can simultaneously extend the DOF without sacrificing the large aperture (NA) and consequent high transverse resolution of conventional fast f-number lenses. A 3-D plot was generated (see FIG. 9) to demonstrate the simultaneous constant intensity distribution along the optical axis and the high lateral resolution of 1 μm the designed system generates. FIG. 9 shows a 3-D simulation plot demonstrating simultaneous ten times DOF improvement with 1 μm transverse resolution.

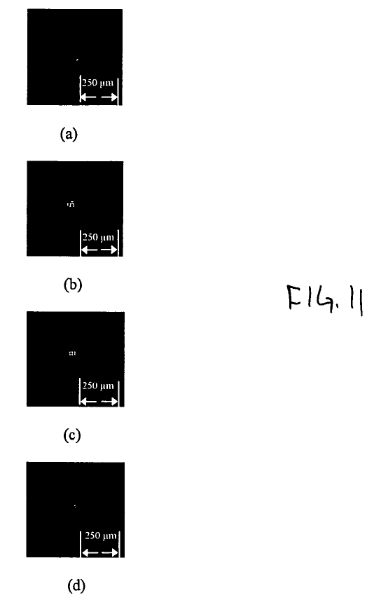

After confirming the functionality of the hybrid lens of the present invention through simulation, a hybrid lens was fabricated, and the point spread imaging (PSI) characteristics of both the hybrid and conventional f/1 lenses were observed and compared. A plano-convex spherical SF11 f/1 lens with 3 mm focal length (model PCX45-118), available from Edmunds Optics of Barrington, N.J., was employed in the experimental analysis of a conventional f/1 lens. Once again, the experimental arrangement detailed in FIG. 5 was utilized to analyze the focusing performance of the sample lenses across the optical axis. The intensity versus axial distance data for the fabricated hybrid sample was recorded and plotted in FIG. 10. FIG. 10 shows an on-axis focus spot intensity variation of the fabricated hybrid refractive-diffractive lens demonstrating the long depth of focus.

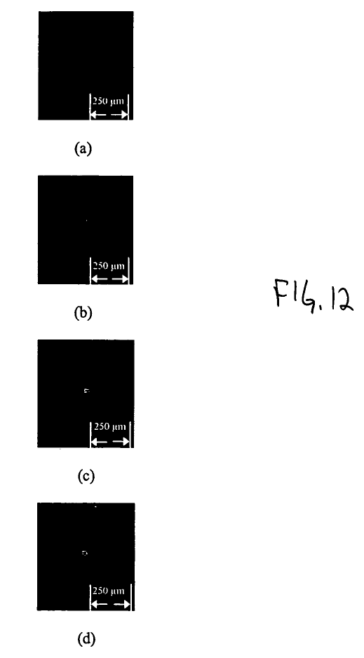

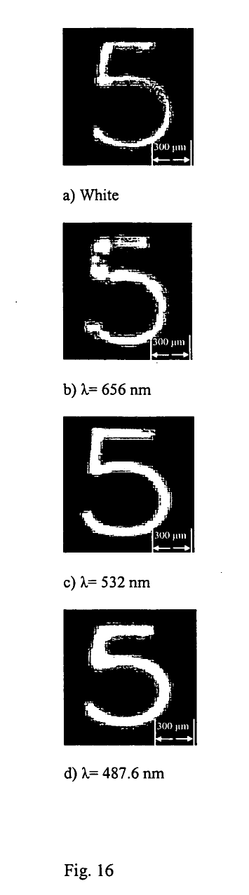

Experimentally acquired images of the beam spot along the optical axis for both the conventional and hybrid f/1 lenses are shown in FIGS. 11 and 12, respectively. FIG. 11 shows experimentally acquired PSI's at focal plane using a conventional f/1 lens at a) 2.999 mm, b) 3.000 mm, c) 3.001 mm, and d) 3.002 mm from the lens. The measured DOF is 2.6 μm. FIG. 12 shows experimentally acquired PSI's at focal plane using our hybrid f/1 lens at a) 2.990 mm, b) 2.997 mm, c) 3.005 mm, and d) 3.01 mm from the lens. The measured DOF is about 20 μm. Experimental results show that the fabricated hybrid lens maintains a focused beam spot for about a 20 μm on-axis range. For a traditional f/1 lens, the beam spot remains in focus for about 2.6 μm. Therefore, a more than seven times DOF improvement over conventional f/1 lenses has been accomplished experimentally. Laser speckles due to the monochromatic nature of the laser beam incidence cause parts of the noises seen in FIG. 12. Such noises are significantly reduced when using an incoherent light source as seen in FIG. 16.

In addition, the on-axis intensity fluctuation as shown in FIG. 10 can be attributed in part to the error inherent in the DOE wet etching process and the propagation nature of the pseudo-non-diffracting beam. Deviation from the expected simulated results (ten times DOF improvement) is also possibly due to the microscopic alignment of the diffractive and refractive portions of the lens. The slight misalignments may lead to off-axis aberrations, which additionally reduce the efficiency of the hybrid lens. The concentricity of DOE with the refractive lens can be improved by using a proper alignment instrument. Improved dry-etching and alignment techniques yield a more accurate DOE and better hybrid lens performance.

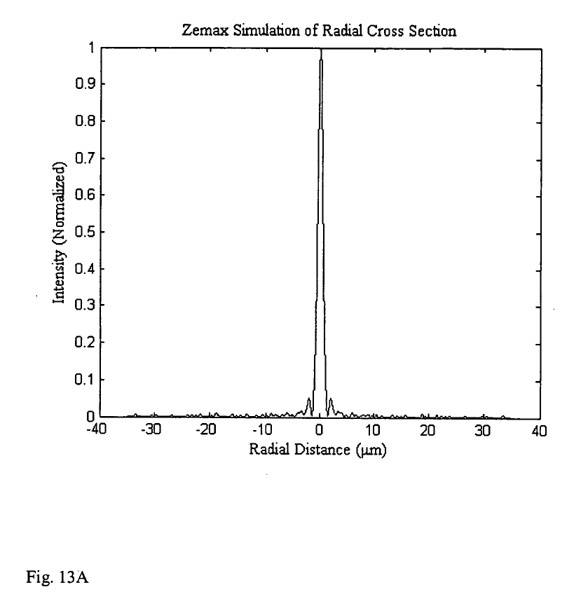

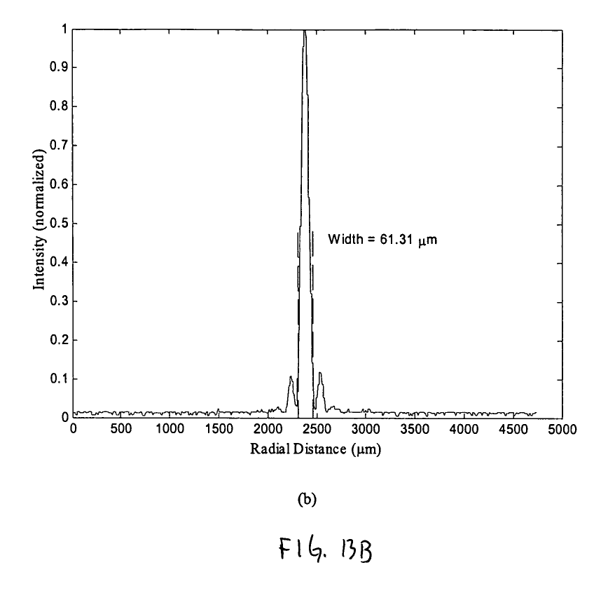

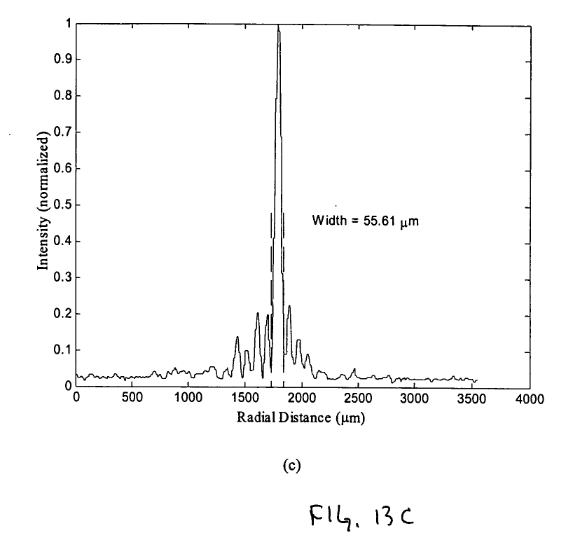

The experimentally acquired beam spot resolutions for both lenses (the conventional lens and the lens of the present invention) were analyzed as shown in FIGS. 13B and 13C, respectively. A ray-tracing software simulation plot of the plano-convex SF11 f/1 lens' spot size at the focal plane is shown in FIG. 13A. FIG. 13A shows a simulation plot of transverse resolution of an SF11 f/1 lens, FIG. 13B shows measured transverse resolution for a conventional f/1 lens, and FIG. 13C shows measured transverse resolution for a hybrid f/1 lens. Note that spot sizes have been obtained using a 60× objective magnification. The near equal resolution of 1 micron (actual width using 60× objective is 60 μm for approximately 1 μm resolution) generated by the hybrid lens illustrates that the hybrid lens preserves the high transverse resolution. Thus, the high resolution of a conventional f/1 lens has been achieved while concurrently extending the depth of focus.

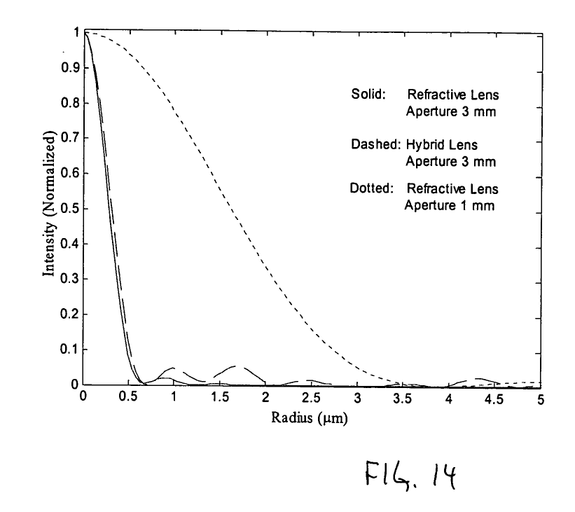

The improvement in DOF using the hybrid lens is accomplished in principle through the introduction of some small side lobes similar to that of the pseudo-non-diffracting beam. As the central lobe diverges after the initial focus, the side lobes converge to offset such diverging effect and thus resulting in the extended depth of focus behavior. These additional side lobes observed in FIG. 13C are in agreement with the pseudo-non-diffracting beam behavior. The additional side lobes may degrade the image quality. The amount of side lobes is, however, significantly smaller than the main low resolution central lobe contributed by the reduced aperture refractive lens of the same DOF as confirmed through the diffraction limited simulation results presented in FIG. 14. Diffraction limited simulation results demonstrating resolution comparison between extended DOF and conventional lens are shown in FIG. 14. The small aperture lens (dotted curve) is designed with the same depth of focus as the extended DOF lens (dashed). The advantage of using the hybrid lens for DOF improvement is thus obvious.

Furthermore, the light efficiency of both lenses was numerically and experimentally analyzed. The light efficiency of the proposed hybrid lens is similar to other optical elements that employ nondiffracting techniques for the generation of constant axial intensity. Since these elements contain somewhat larger sidelobes, some light efficiency is sacrificed. Experimental analysis of the central spot encircled energy yields 1.64% and 2.77% efficiency performance from the Zemax simulation for the conventional and hybrid aberrated f/1 lens, respectively. These results indicate that our hybrid extended-DOF lens has higher efficiency than a similar f/1 conventional lens. The reason is that the aspherical (logarithmic) phase profile of the DOE compensates for some of the spherical aberration that is inherent in conventional refractive lenses, thus leading to the improved experimental efficiency over a conventional spherical lens. Although reduction in the diffraction limited light efficiency is due in part to the pseudo-nondiffracting side lobes, the hybrid lens is able to sustain adequate light efficiency for many applications.

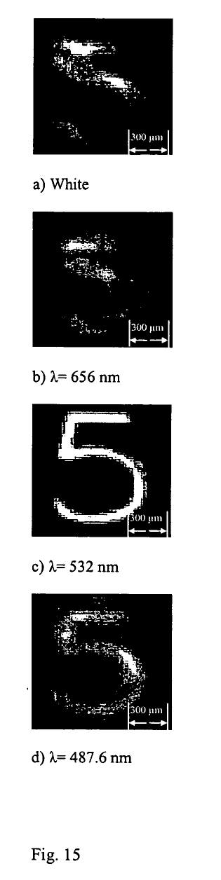

To compare imaging quality, the achromatic performance of the fabricated lens was tested and compared to a conventional f/1 lens. A white light source was used to illuminate a US Air Force resolution target and images were taken with both lenses (the conventional lens and the lens of the present invention). Three 10 nm bandwidth color filters (central wavelengths at 656 nm, 532 nm, and 487.6 nm) were used to generate the red, green, and blue illuminations, respectively, and the number “5” was imaged. The results for a traditional f/1 lens are presented in FIG. 15, and as predicted by FIG. 8C, the effects of chromatic aberration are clearly observed. FIG. 15 shows an image of a portion of the US Air Force Resolution Target taken with a conventional f/1 lens. The target is illuminated with a white light source and separated using color filters.

On the other the hand the chromatic performance of the fabricated hybrid lens (FIG. 16) shows excellent improvement over the conventional lens alone, with only a slight focal shift observed as expected from our simulation results. FIG. 16 shows an image of a portion of the US Air Force Resolution Target taken with the fabricated hybrid f/1 lens. Target is illuminated with white light source and separated using color filters. Unlike other reported long focal depth/high resolution systems that depend on monochromatic illumination, the hybrid lens of the present invention with extended depth of focus and high transverse resolution works over a broad waveband in the visible spectrum. Thus, the aforementioned experiment shows the use of a near achromatic hybrid lens with extended depth of focus.

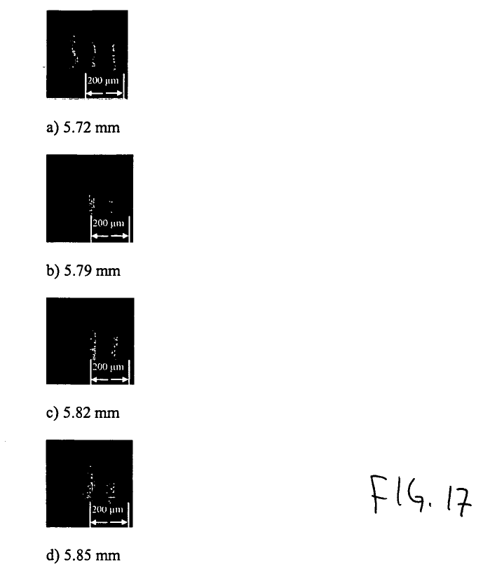

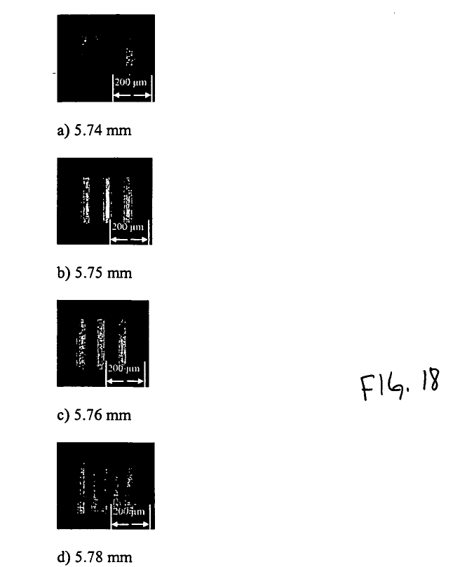

Lastly, the imaging depth of field enhancement is verified by having both hybrid and conventional f/1 lenses image an object placed at various fixed distances from the lenses. The depth of field improvement is examined through imaging comparison of the three bar pattern that appears in the Air Force resolution target. To demonstrate the simultaneous depth of field improvement with high resolution, we imaged the highest resolution segment of the target—Group 7: element 6 (228.10 line pair (LP)/mm). Experimental results show that the three bar pattern appears resolved when the hybrid lens is placed at distances of 5.72 mm to 5.85 mm (see FIG. 17) from the target. FIG. 17 shows focus-free images of 228 LP/mm resolution targets using a hybrid f/1 imaging lens. Clear images are formed from 5.72 mm to 5.85 mm. For a similar system using a conventional f/1 imaging lens, experimental results in FIG. 18, show that the lens resolves the pattern from only 5.75 mm to 5.77 mm. FIG. 18 shows images of 228 LP/mm target patterns with a conventional f/1 lens. Employing the Rayleigh resolution criterion of 73.5% midpoint intensity between the peak intensities of the imaged bars, the traditional imaging lens produces a 0.02 mm depth of field. By comparison, the hybrid lens produces a 0.13 mm field depth. As a result, near a factor-of-7 improvement was experimentally accomplished for the highest resolution target sector. Although the depth of field enhancement presented is accomplished for a high-resolution target portion, similar results are obtained for the low-resolution sectors of the US Air Force target.

In conclusion, the present invention presents a technique for designing achromatic hybrid refractive-diffractive lenses that can extend the depth of focus of conventional lenses while conserving the aperture for equivalent transverse resolution. The working principle is based on a specially designed diffractive optical element that modulates the incident light wave to produce a constant axial intensity distribution within a given long focal range. When combined with a corresponding refractive lens, an achromatic hybrid lens with long focal depth and unaltered transverse resolution can be conceived.

The present invention has been employed to realize a hybrid f/1 lens with over seven times DOF improvement, 1 μm transverse resolution, and efficient operation in the entire visible waveband. The flexibility of the hybrid design technique also allows DOEs with long DOF to be designed for any number of refractive materials. Thus, custom development of hybrid extended depth of focus lenses can be easily achieved. Improved etching and alignment techniques yielding more accurate surface-relief profiles can result in ten times DOF improvement as demonstrated through the simulations presented herein. Since the present invention performs well in the most strenuous case (f/1: fast, high power lens, with large aperture), the reported method should conceivably work well for higher f-number lenses. By minimizing focus adjustment of optical imaging systems, the achromatic hybrid lens of the present invention with long depth of focus and high transverse resolution can benefit various practical optical systems.

Therefore, while there has been described what is presently considered to be the preferred embodiment, it will be understood by those skilled in the art that other modifications can be made within the spirit of the invention.

What is claimed is:

1. A lens, comprising:
a diffractive surface having an etched structure; and
a refractive surface having a curved structure,
wherein chromatic aberration of incident light is reduced and depth of focus is extended.

2. The lens of claim 1, wherein the etched structure is a calculated phase pattern.

3. The lens of claim 1, wherein the etched structure is a pattern that is any one of embossed and diamond tuned.

4. The lens of claim 1, wherein the curved structure is convex shaped.

5. The lens of claim 1, wherein the curved structure is concave shaped.

6. The lens of claim 1, wherein the lens is an imaging lens.

7. The lens of claim 1, wherein high lateral resolution of incident light is preserved.

8. A lens, comprising:
a diffractive surface having an etched structure; and
a refractive element having varying densities,
wherein chromatic aberration of incident light is reduced and depth of focus is extended.

9. The lens of claim 8, wherein the etched structure is a calculated phase pattern.

10. The lens of claim 8, wherein the etched structure is a pattern that is any one of embossed and diamond tuned.

11. The lens of claim 8, wherein the refractive element is a graded index lens.

12. The lens of claim 8, wherein the lens is an imaging lens.

13. The lens of claim 8, wherein high lateral resolution of incident light is preserved.

14. A lens assembly, comprising:
a diffractive lens having an etched structure; and
a refractive lens having a curved structure, the refractive lens being coupled to the diffractive lens,
wherein chromatic aberration of incident light is reduced and depth of focus is extended.

15. The lens assembly of claim 14, wherein the etched structure is a calculated phase pattern.

16. The lens assembly of claim 14, wherein the etched structure is a pattern that is any one of embossed and diamond tuned.

17. The lens assembly of claim 14, wherein the curved structure is convex shaped.

18. The lens assembly of claim 14, wherein the curved structure is concave shaped.

19. The lens assembly of claim 14, wherein the lens assembly is an imaging lens.

20. The lens assembly of claim 14, wherein high lateral resolution of incident light is preserved.

21. A lens assembly, comprising:
a diffractive lens having an etched structure; and
a refractive lens having a curved structure, the refractive lens being coupled to the diffractive lens,
wherein depth of focus of incident light is extended and wherein the diffractive lens and the refractive lens satisfy the following equations:
P=Pᵣ+P_{d} and Pᵣ/Vᵣ+P_{d}/V_{d}=0,
wherein P is total lens assembly optical power, Pᵣ is optical power of the refractive lens, P_{d} is optical power of the diffractive lens, Vᵣ is an Abbe number of the refractive lens material and V_{d} is the equivalent material Abbe number of the diffractive lens.

22. The lens assembly of claim 21, wherein the etched structure is a calculated phase pattern.

23. The lens assembly of claim 21, wherein the etched structure is a pattern that is any one of embossed and diamond tuned.

24. The lens assembly of claim 21, wherein the curved structure is convex shaped.

25. The lens assembly of claim 21, wherein the curved structure is concave shaped.

26. The lens assembly of claim 21, wherein the lens assembly is an imaging lens.

27. The lens assembly of claim 21, wherein high lateral resolution of incident light is preserved.
